(19) United States
(12) Patent Application Publication
(10) Pub. No.: US 2014/0162812 A1
(43) Pub. Date: Jun. 12, 2014

(54) DEVICE WITH A GRIP SIZED TO PROVIDE FORCE CONTROL

(71) Applicant: David Stephen Warren, London (GB)

(72) Inventor: David Stephen Warren, London (GB)

(21) Appl. No.: 14/232,580

(22) PCT Filed: Jul. 13, 2012
(86) PCT No.: PCT/GB2012/051665

§ 371 Date: Jan. 13, 2014

(30) Foreign Application Priority Data
Jul. 14, 2011 (GB) 1112322.1

(51) Int. Cl. A63B 59/00; B25G 1/00; A63B 49/08

(52) U.S. Cl. CPC A63B 59/0014; A63B 49/08; B25G 1/00
USPC 473/549; 16/430; 29/407.01

(57) ABSTRACT

This invention relates to a device comprising a grip (1) matched to the user's hand such that the fingers and thumb are held where the fingers and thumb do not quite meet thus allowing high force of grip whilst having a mobile and yet stable wrist.

This invention relates to a grip, and particularly to a grip for use with sports equipment.

The design of nearly all handheld devices including tennis racquets, cricket bats, javelins, weights bars and rowing or crutch handles etc mean that the forces that need to be applied to use them have the hand in an inappropriate position meaning that it cannot apply full force and limits the speed of movement of the rest of the arm or body. These devices have been designed following tradition and/or flawed understanding of the functional anatomy of the hand. In the case of the tennis racquet, which was invented over 100 years ago, the materials used and the shape and size of the head have altered but the handle of the racquet has not.

The use of conventional devices for prolonged periods of time is also limited by poor design because the internal construction of the hand is not able to function with the minimum amount of stress and tension.

With many existing designs there is the risk of developing repetitive strain injury, tenosynovitis, golfer's elbow, tennis elbow and bicipital tendonitis etc.

To allow the hand to hold or use any device most effectively it is essential that it performs at its anatomical best at all times.

Furthermore the existing ergonomics of various devices have hitherto been designed differently in an attempt to achieve (a) a precision grip or (b) a power grip or (c) a grip to allow good mobility of the limb.

A first aspect of the present invention provides a device comprising a grip matched to the user's hand wherein the fingers and thumb are held so the fingers and thumb do not quite meet around the grip thus allowing high force of grip whilst having a mobile and yet stable wrist.

The actual anatomy of the hand is such that to be most effective it is necessary to have the hand set with the fingers and thumb not quite touching (ideal grip size), including a glove if used, and the user's fingers to abut one another allowing the wrist to transfer additional force in comparison to when the user's fingers do not abut.

With the hand at this position it is possible to gain high force of grip whilst having as mobile and stable a wrist without losing any range of motion at the elbow and/or shoulder joints.

This means that the user will also still have an enlarged sensation of control and touch whilst using the device.

The grip may be smooth along the length that can be held or that the hand could be applied to. If the surface is irregular then the fingers and thumb will not be held in the optimum alignment related to the internal anatomy of the hand.

The fingers may be held together and not apart because when they are divided and not in abutment then the muscles of the hand are placed under strain to re-establish the optimum position of the hand to grip and apply force.

The grip may have a substantially constant diameter to maintain the arrangement of the fingers of the hand to allow the application of high force and better control.

The grip may be made from a resilient material that allows for a small amount of compression on squeezing in a similar way to a boxer's gum shield, the effect of which is that the hand does not tire so quickly and will be able to apply force for longer periods.

The surface of the grip may have a tacky sensation so as to stop the hand feeling as though it is slipping.

The grip may be applied where relevant to any kitchen implement where a force needs to be applied by the user's hand to improve the use of that object.

The grip may be applied as described above to the handle of a suitcase or walking stick etc so that the hand would be at its anatomical optimum to be able to apply a force in lifting, carrying, pulling or pushing down.

A second aspect of the present invention provides a method comprising matching a grip to the user's hand such that the fingers and thumb are held where the fingers and thumb do not quite meet thus allowing high force of grip whilst having a mobile and yet stable wrist.

A third aspect of the present invention provides a method of manufacturing a grip matched to the user's hand such that the fingers and thumb are held where the fingers and thumb do not quite meet thus allowing high force of grip whilst having a mobile and yet stable wrist. The method comprises the steps of measuring a user's hand and manufacturing a grip matched to the user's hand such that the fingers and thumb are held where the fingers and thumb do not quite meet. The grip may take the form discussed above.

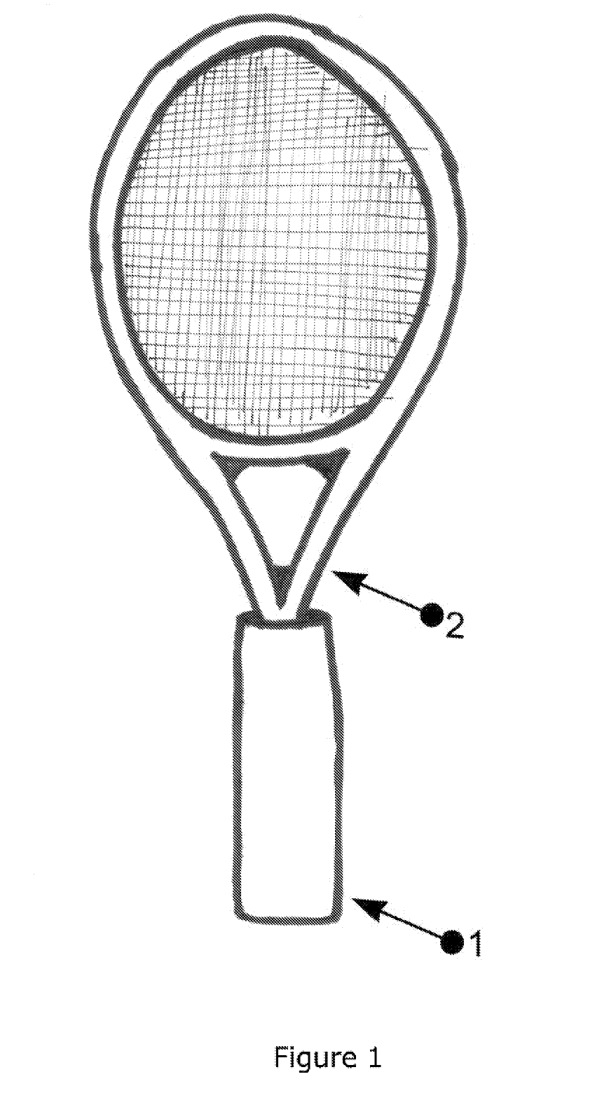

The drawings relate to preferred forms of the invention and are provided by way of example only. FIG. 1 shows a perspective view of a grip applied over the handle of a tennis racquet according to a preferred form of the invention.

FIG. 1 shows a grip 1 comprising a smooth evenly diametered cylinder along the length that can be held or that a hand could be applied to. The diameter of the grip is matched so that the fingers and thumb on either hand do not quite meet whilst the device is being held including any glove if worn.

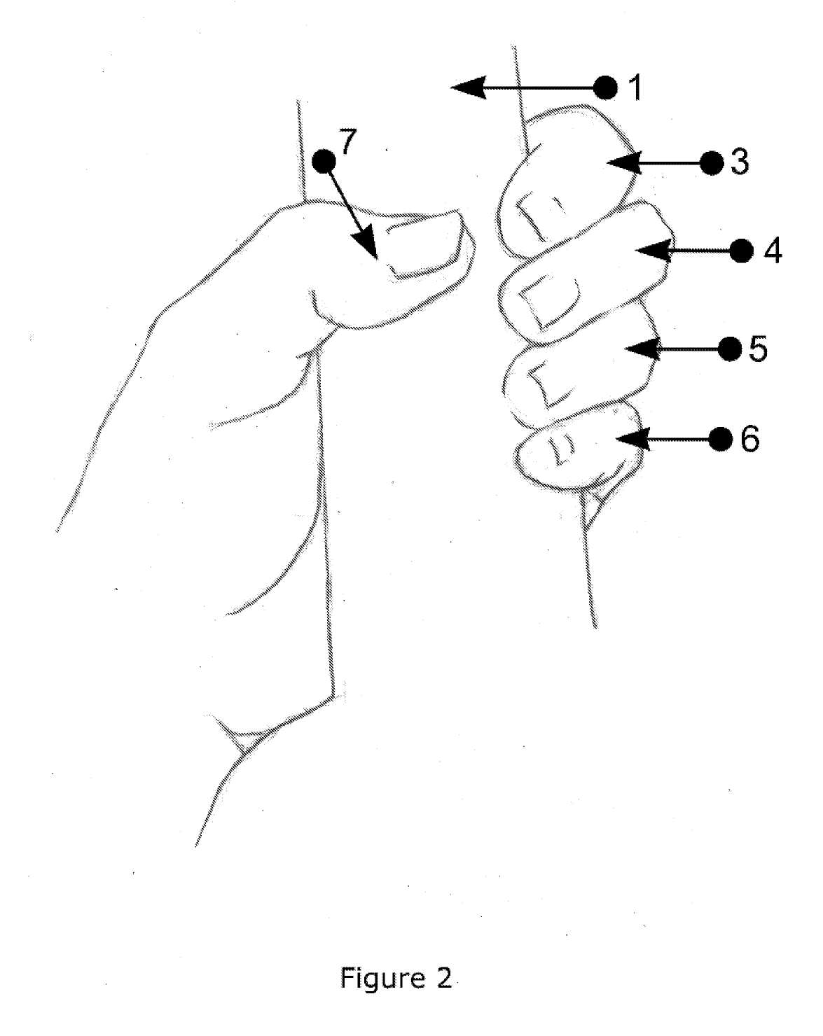

FIG. 2 shows a device comprising a grip matched to the user's hand wherein the fingers 3, 4, 5, 6 and thumb 7 are held where the fingers and thumb do not quite meet around the grip 1 which allows high force of grip whilst having a mobile and yet stable wrist.

The grip is made from a resilient material that allows for a small amount of compression on squeezing and will have a surface that has a tacky sensation to it so as to stop the hand feeling as though it is slipping.

With reference to FIG. 1 the grip 1 is shown to be situated over the entire length of the handle of the racquet 2. The reason for this being that in tennis for example both hands may be applied to the racquet at the same time to perform a shot.

1. A device comprising a grip matched to the user's hand such that the fingers and thumb are held where the fingers and thumb do not quite meet thus allowing high force of grip whilst having a mobile and yet stable wrist.

2. A device as stated in claim 1, wherein the grip is smooth.

3. A device as stated in claim 1, wherein the fingers are held together and not apart.

4. A device as stated in claim 1, wherein the grip has a substantially constant diameter.

5. A device as stated claim 1, wherein the grip is made from a resilient material.

6. A device as stated in claim 1, wherein the grip has a tacky sensation.

7. A device as stated in claim 1, when applied to a whisk, knife or any other kitchen implement.

8. A device as stated in claim 1, when applied to the handle of a suitcase, weights bar or walking stick.

9. A tennis racquet comprising a device of claim 1.

10. A method comprising matching a grip to the user's hand such that the fingers and thumb are held where the fingers and thumb do not quite meet thus allowing high force of grip whilst having a mobile and yet stable wrist.

11. A method as stated in claim 10, wherein the grip is smooth.

12. A method as stated in claim 10, wherein the fingers are held together and not apart.

13. A method as stated in claim 10, wherein the grip has a substantially constant diameter.

14. A method as stated in claim 10, wherein the grip is made from a resilient material.

15. A method as stated in claim 10, wherein the grip has a tacky sensation.

16. A method of manufacturing a grip comprising the steps of measuring a user's hand and manufacturing a grip matched to the user's hand such that the fingers and thumb are held where the fingers and thumb do not quite meet thus allowing high force of grip whilst having a mobile and yet stable wrist.

17. (canceled)

18. (canceled)
